(19) United States
(12) Patent Application Publication
(10) Pub. No.: US 2009/0119152 A1
(43) Pub. Date: May 7, 2009

(54) METHOD OF DESIGNING, MANUFACTURING AND STANDARDIZING CUSTOM-BUILT CHECK STANDS OF DIFFERENT SIZES AND CONFIGURATIONS

(75) Inventors: Michael S. Notheis, Hoschton, GA (US); Earl Seekins, Marietta, GA (US); Jeffrey Hassman, Canton, GA (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ROYSTON, LLC, Jasper, GA (US)

(21) Appl. No.: 11/934,334

(22) Filed: Nov. 2, 2007

(51) Int. Cl. G06Q 10/00; G06Q 30/00

(52) U.S. Cl. 705/10

(57) ABSTRACT

A new method for designing and manufacturing custom-built check stands is provided which involves producing a large database of drawings of modules and component kits for producing check stands. Drawings are selected from this database for producing check stands in response to an order for a custom-built check stand. The drawings can be subsequently modified to eliminate unneeded features or to add needed features on repeat orders of the check stands in order to produce a standardized check stand for these repeat orders.

### TECHNICAL FIELD

This invention relates to a method of designing and manufacturing custom built check stands and the conversion to standardized check stands on subsequent orders.

### BACKGROUND OF THE INVENTION

Many stores have check stands to handle the payment and bagging of merchandise purchased by customers. These check stands frequently have a front transport where the customer can place items to be scanned and bagged by a cashier or for self-service checkout. The front transport may have a conveyor belt or rollers. The check stand also usually has a section where the merchandise is scanned by the cashier and paid for by the customer. The rear end of the check stand may or may not have a conveyor belt but is usually where the items are bagged for the customer to take home.

These check stands are used by stores that sell several items to an individual customer. They are commonly used in grocery stores of any size for handling the purchase and payment of groceries.

There is a tremendous variety of check stands that are made because stores like to have different features on their check stands to save space and to handle their needs and products. Consequently, the manufacture of check stands has been the basis of either standardized check stands with no availability of modifications or options or at the other extreme the manufacture of custom built check stands, that are built to the store's specifications. The manufacture of standardized check stands is obviously more efficient because the drawings have already been produced and it is simply a matter of manufacturing in accordance with those drawings. For customized check stands it is necessary to produce a set of drawings for each order and manufacture of that order. There may or may not be repeat orders of that custom-built check stand. If there are no repeat orders then the manufacturer of the check stand may have to absorb the cost of producing, designing, and drafting drawings and building a custom-built check stand.

### BRIEF DESCRIPTION OF THE DRAWINGS

FIG. 1 is a flow chart of the design and manufacture phases for the conversion from manufacture of custom-built check stands to the manufacture of standardized check stands.

### DETAILED DESCRIPTION OF THE DRAWINGS

This invention is a method for the design and manufacture of custom-built check stands that is planned so that subsequent orders to the manufacturer can be converted to standardized check stands. This is accomplished by first determining the features that customers would like to have in check stands and conceptually breaking check stands down into combinable modules and kits of components for forming modules. Drawings of these modules and kits of components to produce modules are made to form a large database of drawings. The drawings are selected from this database to produce orders for a specific check stand. After the check stand is produced a few times in response to repeat orders, the check stands will be reviewed from the standpoint of producing a standardized check stand. This is done by eliminating features of the modules that are not needed and adding any features that are needed in order to fill repeat orders.

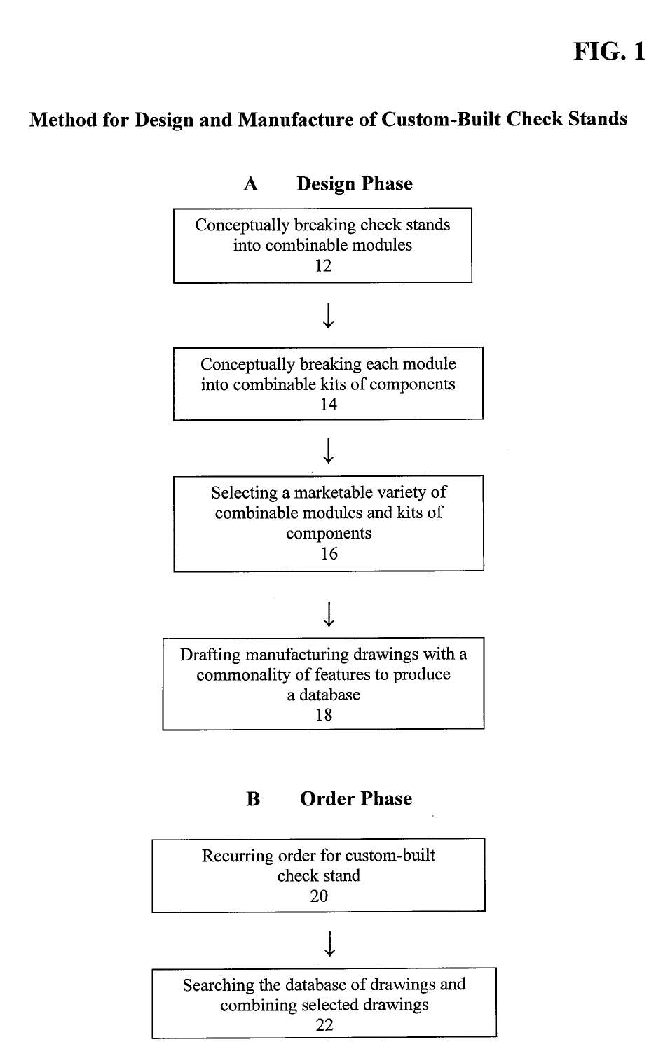

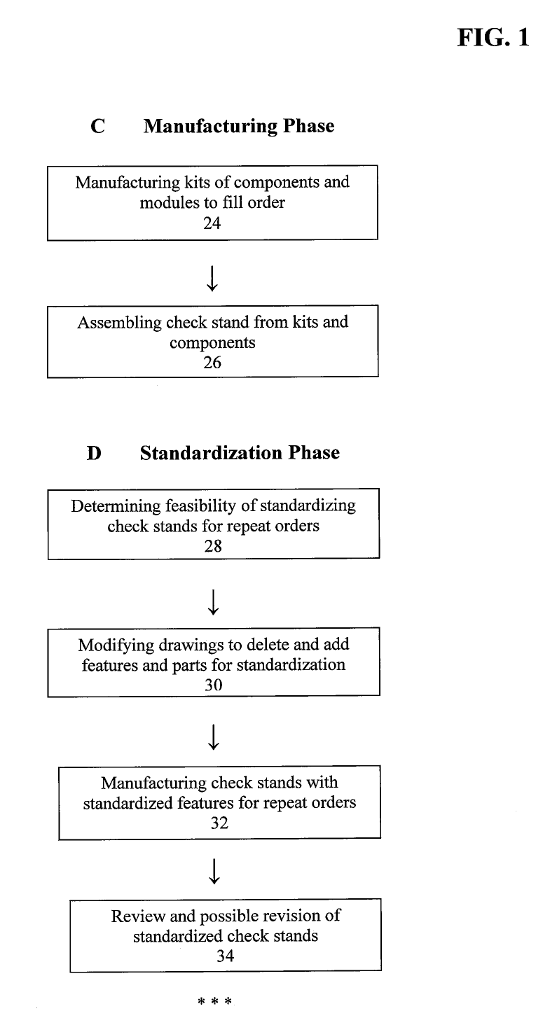

This process is set forth in more detail in FIG. 1. This process for the design and manufacture and subsequent standardization of check stands is divided into four phases. The phases as shown in FIG. 1 are

A) design phase,

B) order phase,

C) manufacturing phase, and

D) standardization phase.

In the design phase A, the check stands are conceptually broken down into modules that can be combined with each other in a mix and match operation 12. Making these check stands in modules makes it much easier to mix and match the modules to produce a custom-built check stand. The modules on a check stand are typically broken down into three basic modules, namely the front transport, the scan section for payment and the rear end where the products purchased are bagged and taken by the customer.

Each of these modules contains a number of different components. Each module needs to be conceptually broken down into various kits of components. It is important that these kits of components be combinable. This step is illustrated by the numeral 14 in FIG. 1.

The next phase of the process is to select a marketable variety of combinable modules and kits of components 16. It is necessary to have a large variety in order to satisfy all customers' desires for check stands. It is important that these modules be selected so that they are combinable and compatible with each other. This is also true of the kits of components.

After all of the kits of components and modules have been conceptually selected, it is now necessary to draft manufacturing drawings 18. These drawings need to have components and modules with a commonality of features.

Upon receiving an order for a custom-built check stand 20 it is necessary in the order phase B to search the database 22 to find the drawings of component kits and modules that are necessary to produce the customer's order. This search can be conducted by using a Boolean-type search or other method for searching the computer database of drawings. A database of 9,000 or more drawings may be necessary to produce the variety of check stands that various customers desire. Once these drawings have been selected they can be combined for manufacture.

In the manufacturing phase C the drawings selected in 22 are used to manufacture the kits of components and modules that are necessary to fill the order 24. After the kit components have been manufactured and assembled into modules, the modules are assembled into check stands 26.

After one or more orders for custom-built check stands have been received with identical specifications, the design and manufacturing process enters a standardization phase D. A feasibility study will be conducted to determine the feasibility of standardizing these check stands for the production of repeat orders 28. In this step the check stands will be analyzed to determine what features are included in the check stand that are not used by a customer and what additional features a customer may like to have that are not included. This can involve something as simple as eliminating punch holes that are not used when the check stands have been placed in a store or as complex as adding significant additional parts or features to the check stand.

Once the features to be eliminated or added have been identified the drawings can be modified to delete and add features and parts for the standardization 30. This standardization aspect is taken into account when the original drawings are produced to make it easier to eliminate or add features and parts.

Once these drawings have been modified, then subsequent orders for check stands with these standardized features shall be manufactured in accordance with these drawings 32.

This method of standardization involves the continual review and possible revision of standardized check stands in respect to repeat orders 34.

This process enables a manufacturer of check stands to manufacture check stands in accordance with orders for custom-built check stands and achieve the advantages of manufacture of standardized check stands. This can only be accomplished by deciding what features customers are going to want on check stands and producing a large database of drawings from which to select to manufacture a particular order. This process enables the manufacturer to produce a check stand within a few days or few weeks in response to an order for a custom-built check stand and then subsequently convert the manufacture to the manufacture of standardized check stands.

Therefore, having thus described the invention, at least the following is claimed:

1. A manufacturing method for the design and drafting of a database of manufacturing drawings, and the manufacture of an ordered custom-built check stand from a group of compatible drawings selected from the database, said check stand being designed for installation in a store for purchasers to check out and pay for items purchased, said custom-built check stand being of a specific specification, design configuration and size as ordered and the conversion to less costly and standardized manufacture of subsequent orders for said same custom-built check stand with any unneeded features being eliminated and adding any needed features or parts without the necessity of extensively modifying the drawings used in manufacture which comprises:
a. designing a check stand by conceptually breaking the check stand into several modules with different functions, said modules being designed so that they can be simply combined after manufacture into a completed check stand;
b. designing different modules of a check stand by conceptually breaking each module into individual kits of components, said kits being designed so that they can be simply combined after manufacture into a completed module;
c. selecting a marketable variety of combinable modules and kits of components, each with different functions, designs, configurations and sizes, for producing check stands based upon marketing knowledge of variations that are thought to be desirable by customers;
d. drafting manufacturing drawings to produce a database for a variety of different modules and kits of components selected in step (c), said drawings being made to include a commonality of features and structures that may be needed in a variety of similar check stands and to also include features or structures that may not be needed in all of the check stands to be manufactured,
said drawings being made so that any unneeded features can be easily eliminated and needed features and parts added in manufacturing check stands without the need for extensive changes in the drawings used;
e. receiving an order for a particular check stand with definite specifications, including dimensions and features;
f. conducting a search of the database to identify the drawings made in accordance with step (d) for producing a check stand in accordance with the order received in step (e) and assembling the drawings selected;
g. manufacturing the kits of components and modules from the drawings selected in step (f) to fill said order;
h. assembling a check stand from the kits of components and modules manufactured in accordance with step (g);
i. determining if the features or structures of said check stands ordered in repeat orders or the features or structures of said check stands actually used in stores on the repeat orders are sufficiently uniform so that the manufacture of subsequent orders of said check stands should be standardized;
j. if it is determined that the manufacture of said check stands should be standardized: (i) deleting features from the drawings of modules and kits of components to produce said check stand for future orders to eliminate any feature or structure not needed for said check stand that can be eliminated to reduce costs of manufacture and assembly and (ii) adding any features or parts to the drawings of modules and kits of components to produce said check stand for future orders and to add any feature or part desired for standardizing said check stand; and
k. producing said check stands in accordance with the drawings with deleted or added features or parts as set forth in step (j) to produce check stands in response to future orders.

2. The manufacturing method of claim 1 in which only features are deleted from the drawings in step (j) for the production of repeat orders.
